(19) United States
(12) Patent Application Publication
(10) Pub. No.: US 2023/0174685 A1
(43) Pub. Date: Jun. 8, 2023

(54) A PROCESS AND APPARATUS FOR PRODUCING AQUEOUS COMPOSITIONS OF WATER-SOLUBLE POLYMERS

(71) Applicant: BASF SE, Ludwigshafen am Rhein (DE)

(72) Inventors: Dennis LOESCH, Ludwigshafen am Rhein (DE); Esther Matyka LARYEA, Ludwigshafen am Rhein (DE); Anna-Corina SCHMIDT, Trostberg (DE); Faissal-Ali EL-TOUFAILI, Ludwigshafen am Rhein (DE); Daniel BARRERA-MEDRANO, Ludwigshafen am Rhein (DE); Markus OSTERMAYR, Ludwigshafen am Rhein (DE)

(21) Appl. No.: 17/922,793

(22) PCT Filed: Apr. 26, 2021
(86) PCT No.: PCT/EP2021/060800

§ 371 Date: Nov. 2, 2022

(30) Foreign Application Priority Data
May 4, 2020 (EP) 20172807.8

(51) Int. Cl. C08F 6/00; C08F 220/56

(52) U.S. Cl. CPC C08F 6/008; C08F 220/56

(57) ABSTRACT

Process for producing aqueous compositions of water-soluble polymers from aqueous polymer gels by comminuting and mixing the aqueous polymer gel with an aqueous liquid by means of a comminution unit comprising a flow-chamber, a sheet-like molding tool and rotating cutting means, wherein a stream of an aqueous liquid flows through the flow chamber, aqueous polymer gel is pressed through the sheet-like molding tool, cutting the thus formed gel strands into slices, dispersing them in the aqueous liquid and homogenizing the thus obtained mixture.

The invention relates to a process for producing aqueous compositions of water-soluble polymers from aqueous polymer gels by comminuting and mixing the aqueous polymer gel with an aqueous liquid by means of a comminution unit comprising a flow-chamber, a sheet-like molding tool and rotating cutting means, wherein a stream of an aqueous liquid flows through the flow chamber, aqueous polymer gel is pressed through the sheet-like molding tool, cutting the thus formed gel strands into slices, dispersing them in the aqueous liquid and homogenizing the thus obtained mixture.

Water-soluble, high molecular weight homo- and copolymers of water-soluble, monoethylenically unsaturated monomers such as for example acrylamide, acrylic acid, or ATBS are known in the art and may be used for various applications.

A common polymerization technology for manufacturing such high molecular weight polymers is the so called “gel polymerization”. In gel polymerization, an aqueous monomer solution having a relatively high concentration of monomers, for example from 20% by weight to 35% by weight is polymerized by means of suitable polymerization initiators under essentially adiabatic conditions in an unstirred reactor thereby forming a polymer gel.

Such polymer gels formed often are converted to polymer powders by comminuting the gel into smaller pieces by one or more size reduction steps, drying such gel pieces for example in a fluid bed dryer followed by sieving, grinding and packaging. The obtained polymer powders, for example polyacrylamide powders are packaged and shipped to customers for use, for example in mining and oilfield applications, water treatment, sewage treatment, papermaking, and agriculture.

The polymer gel obtained from gel polymerization typically comprises from 65 wt.% to 80 wt.% of water. The residual amount of water in polyacrylamide powders typically is from about 4 to 12 wt.%. So, “drying” such polyacrylamide gels does not mean to remove only some residual moisture but rather about 0.55 kg to 0.75 kg of water need to be removed per kg of polymer gel, or -with other words- per kg of polymer powder produced also 1.5 to 2.5 kg of water are “produced”.

It goes without saying that removing such a high amount of water from the polymer gel in course of drying is energy extensive and consequently the operational costs for drying are high. Furthermore, high-performance dryers are necessary as well as equipment for size reduction, sieving and grinding. Consequently, the capital expenditure for the entire post-processing equipment including size reduction, drying, sieving, grinding is significant in relation to the total capital expenditure for the entire plant.

It has therefore been suggested not to dry aqueous polymer gels after manufacture but directly dissolving said aqueous polymer gels in water thereby obtaining diluted aqueous solutions of water-soluble polymers such as polyacrylamides without drying and re-dissolving the dry powder. Advantageously, dissolving aqueous polymer gels in water may be carried out on-site, i.e. at the side at which the solutions of water-soluble polymers are used.

Several technologies have been suggested for dissolving aqueous polymer gels in water.

DE 21 08 703 discloses a method of dissolving polymer gels by rubbing the gel against a rough surface in the presence of water.

GB 1 441 340 discloses a method of dissolving polymer gels by extruding the aqueous polymer gel through an orifice in an orifice sheet having an inside surface and an outside surface, periodically cutting the gel at the inside of the orifice sheet and continuing extruding, impinging solvent for the gel on the exiting segmented gel strand exiting from the outside of the orifice sheet, mixing the gel particles and solvent to dissolve the gel particles in the solvent.

US 3,255,142 discloses a method of dissolving polymer gels by extruding said polymer gels into a transversely flowing stream of liquid solvent.

US 4,113,688 discloses a 2-step method of dissolving polymer gels. Specifically, the method comprises two size reduction steps. The first size reduction step comprises extruding said polymer gels into flowing water through die perforations in an extrusion die sheet, said perforations having a diameter of ~ 0.15 mm to ~ 12.7 mm, forming polymer gel strands, and cutting such polymer gel strands to a length of less than ~ 19.05 mm, thereby obtaining a slurry of the cut gel particles in the flowing water. In the second size reduction step, the slurry of gel particles is subjected to high shear forces immediately after formation of such slurry, i.e. before any substantial dissolution of the polymer gel occurs, thereby reducing the average maximum dimension of the gel particles to less than 0.76 mm. Finally, the resultant slurry of fine gel particles and additional water are mixed under low shear conditions thereby forming a dilute aqueous solution of the polymer.

US 4,845,192 discloses a method of rapidly dissolving particles of gels of water-soluble polymers comprising forming a suspension of such gel particles in water and subjecting said suspension to instantaneous and momentary conditions of high shearing effective to finely slice said particles.

US 4,605,689 discloses a method for on-site production of aqueous polyacrylamide solutions for enhanced oil recovery. In a first step an aqueous polyacrylamide gel is provided by polymerizing acrylamide and preferably acrylic acid as comonomer. The aqueous polyacrylamide gel obtained is conveyed together with a minor amount of aqueous solvent through at least one static cutting device thereby obtaining a slurry of small gel particles in water, the gel particles are dissolved in the aqueous solvent which forms a homogeneous solution concentrate which is then readily diluted with aqueous solvent thereby obtaining a diluted aqueous polyacrylamide solution.

WO 2017/186567 A1 relates to a process for producing an aqueous polymer solution comprising the steps of providing an aqueous polymer gel comprising at least 10% by weight of active polymer, cutting the aqueous polyacrylamide gel by means of a water-jet at a pressure of at least 150 bar to reduce the size of the aqueous polymer gel, and dissolving the aqueous polymer gel in an aqueous liquid.

WO 2017/186697 A1 relates to a method of preparing an aqueous polyacrylamide solution, comprising hydrolyzing acrylonitrile in water in presence of a biocatalyst thereby obtaining an acrylamide solution, directly polymerizing the acrylamide solution thereby obtaining a polyacrylamide gel, and directly dissolving the polyacrylamide gel by addition of water, preferably by means of a static mixer, thereby obtaining an aqueous polyacrylamide solution. The method may be carried out on-site. WO 2017/186685 A1 relates to a similar method of preparing an aqueous polyacrylamide solution, in which dissolving the polyacrylamide gel in water is carried out by means of a mixer comprising a rotatable impeller. Such a mixer is also known in the art as Urschel-mixer and applies high shearing forces. WO 2017/186698 A1 relates to a similar method of preparing an aqueous polyacrylamide solution, in which dissolving the polyacrylamide gel in water is carried out by means of water jet cutting.

WO 2019/081318 A1, WO 2019/081319 A1, WO 2019/081320 A1, WO 2019/081321 A1, WO 2019/081323 A1, WO 2019/081327 A1, and WO 2019/081330 A1 disclose the manufacture of aqueous polyacrylamide solutions on-site in modular plants by adiabatic gel polymerization of aqueous solutions comprising acrylamide and optionally further monoethylenically unsaturated comonomers followed by comminuting and dissolving the aqueous gel obtained in water thereby yielding an aqueous polyacrylamide solution. The applications suggest several comminution technologies. Examples of suitable means for comminuting aqueous polyacrylamide gels include cutting devices such as knives or perforated plates, crushers, kneaders, static mixers or water-jets or combinations thereof.

WO 2019/081324 A1 discloses a method of preparing an aqueous polyacrylamide solution comprising conveying an aqueous polymer gel through a comminution unit comprising at least a perforated sheet and moveable cutting means and adding at least a portion of the aqueous liquid into the comminution unit, wherein the relative velocity between the cutting means and the aqueous polymer gel does not exceed 3 m/s, thereby obtaining an aqueous mixture comprising an aqueous liquid comprising dissolved aqueous polymer and undissolved pieces of aqueous polymer gel, adding the remainder of the aqueous liquid to the mixture and dissolving the aqueous polymer gel pieces in the aqueous liquid. The document furthermore discloses a suitable apparatus for carrying out the process.

WO 2020/079152 A1 discloses a method of making aqueous polyacrylamide concentrates having a concentration of 1 to 14.9% by wt., preferably 3.1% by wt. to 7 % by wt. of polyacrylamides by adiabatic gel polymerization of aqueous solutions comprising acrylamide and optionally further monoethylenically unsaturated comonomers followed by comminuting and mixing the aqueous gel with water thereby yielding the abovementioned aqueous polyacrylamide concentrate. The concentrate may thereafter be transported to another location for use. The application suggests several technologies for comminution and mixing with water. Examples comprise static cutting devices, perforated plates, optionally in combination with a rotating knife, static mixers, water-jet cutters or combinations thereof such as a combination of water-jet cutting with static cutting members or with static mixers.

Our older application WO 2020/216433 A1 discloses a process for comminuting and mixing with water aqueous polymer gels which comprises a comminution unit comprising a hollow cylinder comprising holes, a flow chamber enclosing circumferentially the lateral area of the hollow cylinder and cutting means rotating around the hollow cylinder. A stream of an aqueous liquid flows through the flow chamber. The aqueous polymer gel is pressed from the inside of the hollow cylinder through the holes into the flow chamber, where it is cut into pieces by the cutting means and mixing with the aqueous liquid flowing through the flow chamber.

It is known in the art to make pellets of thermoplastic polymers, such as polyethylene, polypropylene of polystyrene by extruding a melt of the thermoplastic polymers through a perforated plate or similar molding tools into flowing water and cutting the thus formed polymer strands thereby obtaining pellets of thermoplastic polymers suspended in water, such as for instance described in “Ullmann’s Encyclopedia of Industrial Chemistry, Plastics Processing, 1. Processing of Thermoplastics, 2.3 Pelletizing, pages 158 to 159″, 2012 Wiley-VCH Verlag GmbH & Co. KGaA, Weinheim, DOI: 10.1002/14356007.a20_663.pub2. Such a process is also known as underwater granulation. Examples of further publications about processes and devices for underwater granulation comprise EP 302 621 A1, US 4,529,370, WO 2007/147162 A2, WO 2005/011944 A2, WO 2005/011945 A1 or WO 2013/178220 A1. Suitable devices for underwater granulation are commercially available.

Surprisingly, it has been found that devices for underwater granulation of thermoplastic polymers are also suitable for dissolving aqueous polyacrylamide gels in water quickly thereby yielding high-quality aqueous solutions of polyacrylamides.

Accordingly, aprocess for providing aqueous polymer compositions has been found, comprising at least the steps of
[1] providing an aqueous polymer gel comprising 15% to 45% by weight of a water-soluble polymer obtainable by polymerization of an aqueous solution comprising water-soluble, monoethylenically unsaturated monomers,
[2] comminuting and mixing the aqueous polymer gel with an aqueous liquid, wherein step [2] comprises conveying the aqueous polymer gel through a comminution unit, comprising at least
   a flow chamber (3) comprising an inlet (5) and an outlet (6) for aqueous liquid,
   a gel inlet (1) which is connected with the flow chamber (3),
   a sheet-like molding tool (2), which separates the flow chamber (3) from the gel inlet (1), comprising a plurality of perforations (7) having a diameter d,
   rotating cutting means (4) arranged within the flow chamber (3), wherein the distance between the cutting edge of the rotating cutting means and the surface of the sheet-like molding tool is ≤ 1 mm,
   a drive for rotating the cutting means,
   means for pressing aqueous polymer gel through the sheet-like molding tool,
   wherein
   the aqueous polymer gel (8) is introduced into the gel inlet (1) at a pressure sufficient to pass through the perforations (7) of the sheet-like molding tool (2), thereby forming polymer gel strands,
   a stream of an aqueous liquid is introduced into the flow chamber (3) through the inlet (5),
   the polymer gel strands are cut by the rotating cutting means, wherein the rotational speed of the rotating cutting means and the speed of the polymer gel strands exiting through the perforations (7) is adjusted in such a manner, that the polymer gel strands are cut into slices having a thickness s, wherein s/d < 1, and the slices are dispersed in the aqueous liquid, thereby obtaining an aqueous mixture comprising an aqueous liquid comprising dissolved aqueous polymer and undissolved aqueous polymer gel, and
   a stream of an aqueous mixture comprising an aqueous liquid comprising dissolved aqueous polymer and undissolved aqueous polymer gel is removed from the flow chamber through the outlet (6), and
[3] homogenizing the aqueous mixture obtained in course of step [2], thereby obtaining an aqueous polymer composition comprising at least an aqueous liquid and water-soluble polymer, wherein the concentration of the polymer is less than 15% by weight, relating to the total of all components of the aqueous polymer composition.

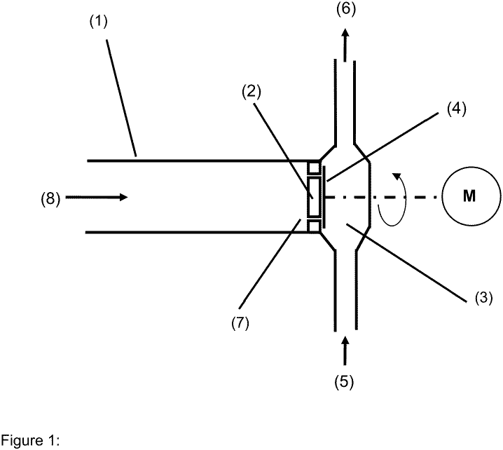

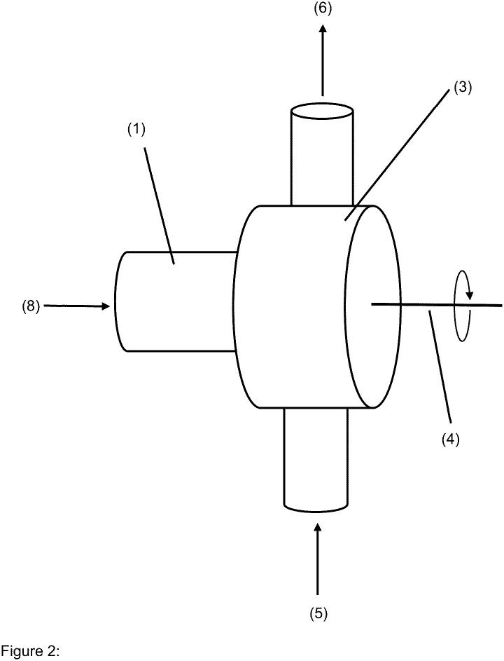

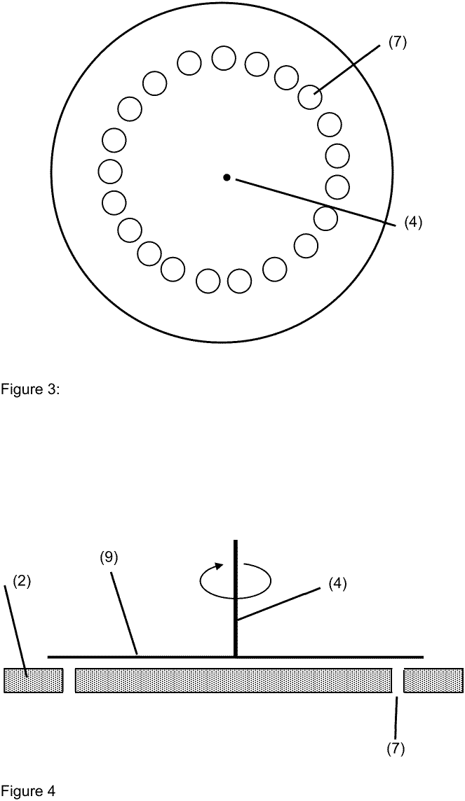

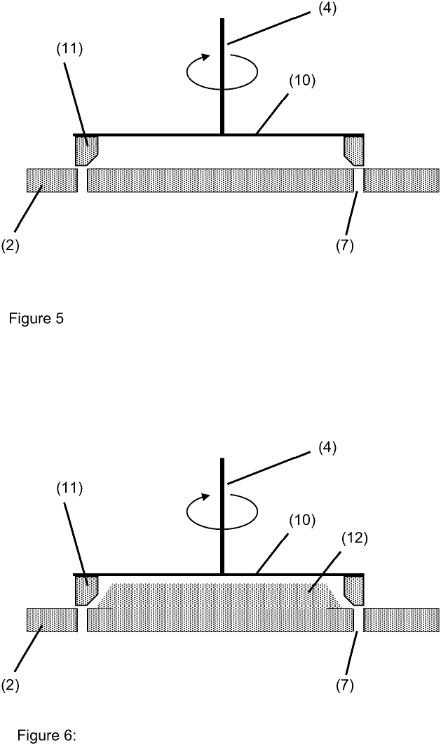

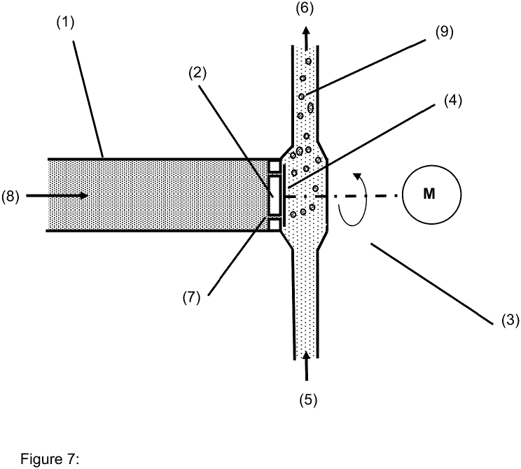

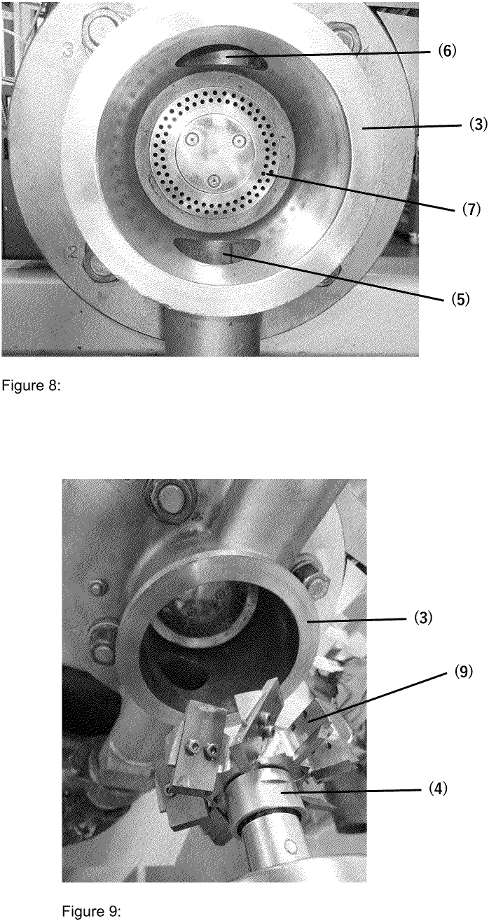

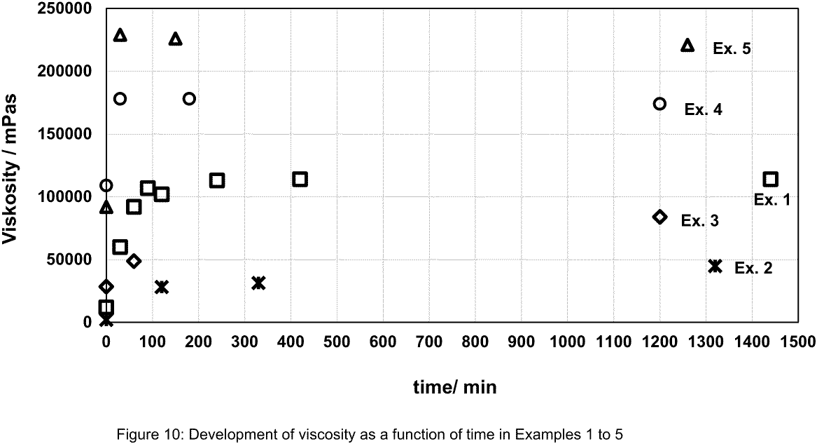

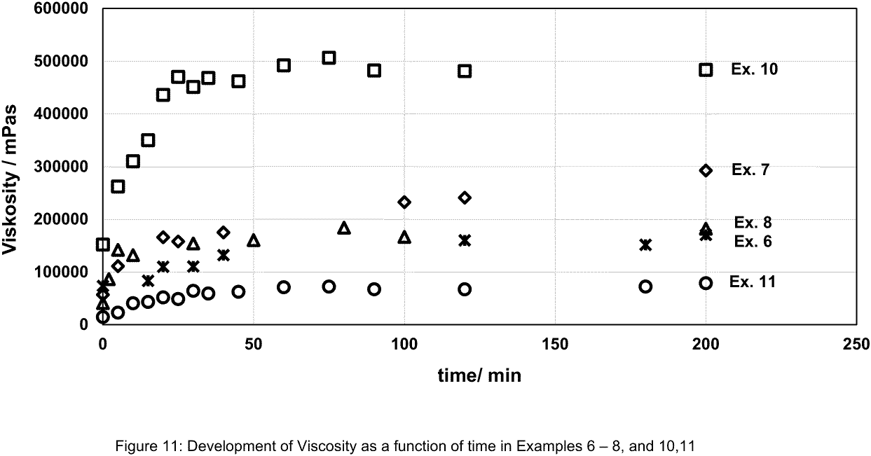

List of figures

| | |
|---|---|
| FIG. 1 | Schematic drawing a comminution unit to be used for the process according to the present invention. |
| FIG. 2 | Schematic representation of one embodiment of flow chamber. |
| FIG. 3 | Schematic drawing of one embodiment of a sheet-like molding tool (view from above). |
| FIG. 4 | Schematic drawing of one embodiment of a sheet-like molding tool (profile) including rotating cutting means. |
| FIG. 5 | Schematic drawing of another embodiment of a sheet-like molding tool (profile) including rotating cutting means comprising a carrier disc and a plurality of knives. |
| FIG. 6 | Schematic drawing of another embodiment of a sheet-like molding tool (profile) including rotating cutting means comprising a carrier disc and a plurality of knives and furthermore a displacement device |
| FIG. 7 | Schematic drawing of the operating principle of the comminution unit to be used for the process according to the present invention. |
| FIG. 8 | Front view of the opened flow chamber |
| FIG. 9 | Flow-chamber with rotating cutting means |
| FIG. 10 | Development of viscosity as a function of time in Examples 1 to 5 |
| FIG. 11 | Development of viscosity as a function of time in Examples 6–8, and 10, 11 |

With regard to the invention, the following can be stated specifically:

By means of the process according to the present invention, it is possible to prepare aqueous compositions of water-soluble polymers, wherein the concentration of the polymer is less than 15% by weight, relating to the total of all components of the aqueous polymer composition, using as starting material an aqueous polymer gel comprising 15 to 45% by weight of water-soluble polymers, wherein the aqueous polymer gel is obtainable by polymerization of an aqueous solution comprising water-soluble, monoethylenically unsaturated monomers.

Such an aqueous polymer gel may be regarded as a polymer-water system in which there is a three-dimensional network structure composed of macromolecules or their associates and which is capable of retaining significant amounts of water. Such a system keeps its shape under the action of its own weight and differs in this feature from a polymer solution. Suitable definition of a polymer gel is given in the article by LZ Rogovina et al, Polymer Science, Ser. C, 2008, Vol. 50, No. 1, pp. 85-92.

The aqueous polymer gel comprises 15% by weight to 45% by weight of a water-soluble polymer, wherein the percentages relate to the total of all components of the aqueous polymer gel. Suitably the contents of water-soluble polymer in the aqueous polymer gel may be from 20% to 45% by weight, desirably from 20% to 40% by weight, preferably from 20 to 35% by weight and for example from 20 to 25% by weight.

### Aqueous Polymer Gel

The aqueous polymer gel comprising water-soluble polymers to be used as starting material is obtainable by polymerization of an aqueous solution comprising water-soluble, monoethylenically unsaturated monomers. Preferably, polymerization is conducted by radical polymerization.

The term “water-soluble polymers” in the context of this invention means “substantially water-soluble polymers”, i.e. the polymers are soluble in water at the desired concentration of use, however, it is not ruled out that they might comprise small amounts of water-insoluble components. The amounts of water-insoluble components which is acceptable depends on the intended use of the polymer.

The water-solubility of the polymers is ensured by the use of water-soluble, monoethylenically unsaturated monomers. The term “water-soluble monomers” in the context of this invention means that the monomers are to be soluble in the aqueous monomer solution to be used for polymerization in the desired use concentration. It is thus not absolutely necessary that the monomers to be used are miscible with water without any gap; instead, it is sufficient if they meet the minimum requirement mentioned. It is to be noted that the presence of one monoethylenically unsaturated monomer in the monomer solution, for example acrylamide or acrylic acid, might enhance the solubility of other monomers as compared to water only. In general, the solubility of the water-soluble monomers in water at room temperature should be at least 50 g/l, preferably at least 100 g/l.

In a preferred embodiment of the invention the aqueous polymer gels are aqueous polyacrylamide gels. The term “polyacrylamide” as used herein means water-soluble polymers comprising at least 10%, preferably at least 20%, and more preferably at least 30% by weight of acrylamide, wherein the amounts relate to the total amount of all monomers relating to the polymer. Polyacrylamides include homopolymers and copolymers of acrylamide and other monoethylenically unsaturated comonomers. Polyacrylamide copolymers are preferred.

Basically, the kind and amount of water-soluble, monoethylenically unsaturated comonomers to be used is not limited and depends on the desired properties and the desired use of the aqueous solutions of polymers to be manufactured.

### Neutral Monomers

Examples of suitable monomers comprise uncharged water-soluble, monoethylenically unsaturated monomers. Examples comprise acrylamide, methacrylamide, N-methyl(meth)acrylamide, N,N′-dimethyl(meth)acrylamide, N-methylol(meth)acrylamide or N-vinylpyrrolidone. Further examples have been mentioned in WO 2015/158517 A1 page 7, lines 9 to 14. In one embodiment of the invention, at least one of the water-soluble, monoethylenically unsaturated monomers in the aqueous monomer solution is acrylamide.

### Anionic Monomers

Further examples of suitable monomers comprise water-soluble, monoethylenically unsaturated monomers comprising at least one acid group, or salts thereof. The acidic groups are preferably selected from the group of —COOH, —SO₃H and —PO₃H₂ or salts thereof. Preference is given to monomers comprising COOH groups and/or —SO₃H groups or salts thereof. Suitable counterions include especially alkali metal ions such as Li⁺, Na⁺ or K⁺, and also ammonium ions such as NH₄⁺ or ammonium ions having organic radicals. Examples of ammonium ions having organic radicals include [NH(CH₃)₃]⁺, [NH₂(CH₃)₂]⁺, [NH₃(CH₃)]⁺, [NH(C2H₅)3]⁺, [NH₂(C₂H₅)_{2]}⁺, [NH₃(C₂H₅)]⁺, [NH₃(CH₂CH₂OH)]⁺, [H₃N—CH₂CH₂—NH₃]²⁺ or [H(H₃C)₂N—CH₂CH₂CH₂NH₃]²⁺.

Examples of monomers comprising —COOH groups include acrylic acid, methacrylic acid, crotonic acid, itaconic acid, maleic acid or fumaric acid or salts thereof. Preference is given to acrylic acid or salts thereof.

Examples of monomers comprising —SO₃H groups or salts thereof include vinylsulfonic acid, allylsulfonic acid, 2-acrylamido-2-methylpropanesulfonic acid (ATBS), 2-methacrylamido-2-methylpropanesulfonic acid, 2-acrylamidobutanesulfonic acid, 3-acrylamido-3-methylbutanesulfonic acid or 2-acrylamido-2,4,4-trimethylpentanesulfonic acid. Preference is given to 2-acrylamido-2-methylpropanesulfonic acid (ATBS) or salts thereof.

Examples of monomers comprising —PO₃H₂ groups or salts thereof include vinylphosphonic acid, allylphosphonic acid, N-(meth)acrylamidoalkylphosphonic acids or (meth)acryloyloxyalkylphosphonic acids, preferably vinylphosphonic acid.

Preferred monomers comprising acidic groups comprise acrylic acid and/or ATBS or salts thereof.

### Cationic Monomers

Further examples of monomers comprise water-soluble, monoethylenically unsaturated monomers comprising cationic groups. Suitable cationic monomers include especially monomers having ammonium groups, especially ammonium derivatives of N-(co-aminoalkyl)(meth)acrylamides or ω-aminoalkyl (meth)acrylates such as 2-trimethylammoniooethyl acrylate chloride H₂C═CH—CO—CH₂CH₂N⁺(CH₃)₃ Cl^{—}(DMA3Q). Further examples have been mentioned in WO 2015/158517 A1 page 8, lines 15 to 37. Preference is given to DMA3Q.

### Associative Monomers

In one embodiment, the monomers comprise at least one associative monomer. Associative monomers typically may only be used as comonomers besides other monoethylenically unsaturated monomers, in particular besides acrylamide.

Associative monomers impart hydrophobically associating properties to polymers, in particular to polyacrylamides. Associative monomers to be used in the context of this invention are water-soluble, monoethylenically unsaturated monomers having at least one hydrophilic group and at least one, preferably terminal, hydrophobic group. Examples of associative monomers have been described for example in WO 2010/133527, WO 2012/069478, WO 2015/086468 or WO 2015/158517.

“Hydrophobically associating copolymers” are understood by a person skilled in the art to mean water-soluble copolymers which, as well as hydrophilic units (in a sufficient amount to assure water solubility), have hydrophobic groups in lateral or terminal positions. In aqueous solution, the hydrophobic groups can associate with one another. Because of this associative interaction, there is an increase in the viscosity of the aqueous polymer solution compared to a polymer of the same kind that merely does not have any associative groups.

Examples of suitable associative monomers comprise monomers having the general formula H₂C═C(R¹)—R²—R³ (I) wherein R¹ is H or methyl, R² is a linking hydrophilic group and R³ is a terminal hydrophobic group. Further examples comprise having the general formula H₂C═C(R¹)—R²—R³—R⁴ (II) wherein R¹, R² and R³ are each as defined above, and R⁴ is a hydrophilic group.

The linking hydrophilic R² group may be a group comprising ethylene oxide units, for example a group comprising 5 to 80 ethylene oxide units, which is joined to the H₂C═C(R¹)— group in a suitable manner, for example by means of a single bond or of a suitable linking group. In another embodiment, the hydrophilic linking group R² may be a group comprising quaternary ammonium groups.

In one embodiment, the associative monomers are monomers of the general formula H₂C═C(R¹)—O—(CH₂CH₂O)ₖ—R^{3a} (III) or H₂C═C(R⁵)—(C═O)—O—(CH₂CH₂O)ₖ—R^{3a} (IV), wherein R¹ has the meaning defined above and k is a number from 10 to 80, for example, 20 to 40. R^{3a} is an aliphatic and/or aromatic, straight-chain or branched hydrocarbyl radical having 8 to 40 carbon atoms, preferably 12 to 32 carbon atoms. Examples of such groups include n-octyl, n-decyl, n-dodecyl, n-tetradecyl, n-hexadecyl or n-octadecyl groups. In a further embodiment, the groups are aromatic groups, especially substituted phenyl radicals, especially distyrylphenyl groups and/or tristyrylphenyl groups.

In another embodiment, the associative monomers are monomers of the general formula H₂C═C(R¹)—O—(CH₂)ₙ—O—(CH₂CH₂O)ₓ—(CH₂—CH(R⁵)O)_{y}—(CH₂CH₂O)_{z}H (V), wherein R¹ is defined as above and the R⁵ radicals are each independently selected from hydrocarbyl radicals comprising at least 2 carbon atoms, preferably from ethyl or propyl groups. In formula (V) n is a natural number from 2 to 6, for example 4, x is a number from 10 to 50, preferably from 12 to 40, and for example, from 20 to 30 and y is a number from 5 to 30, preferably 8 to 25. In formula (V), z is a number from 0 to 5, for example 1 to 4, i.e. the terminal block of ethylene oxide units is thus merely optionally present. In an embodiment of the invention, it is possible to use at least two monomers (V), wherein the R¹ and R⁶ radicals and indices n, x and y are each the same, but in one of the monomers z = 0 while z > 0 in the other, preferably 1 to 4.

In another embodiment, the associative monomers are cationic monomers. Examples of cationic associative monomers have been disclosed in WO 2015/158517 A1, page 11, line 20 to page 12, lines 14 to 42. In one embodiment, the cationic monomers having the general formula H₂C═C(R¹)—C(═O)O—(CH₂)ₖ—N⁺(CH₃)(CH₃)(R⁶) X— (VI) or H₂C═C(R¹)—C(═O)N(R¹)—(CH₂)ₖ—N⁺(CH₃)(CH₃)(R⁶) X^{—} (VII) may be used, wherein R¹ has the meaning as defined above, k is 2 or 3, R⁶ is a hydrocarbyl group, preferably an aliphatic hydrocarbyl group, having 8 to 18 carbon atoms, and X⁻ is a negatively charged counterion, preferably Cl⁻ and/or Br⁻.

### Further Monomers

Besides water-soluble monoethylenically unsaturated monomers, also water-soluble, ethylenically unsaturated monomers having more than one ethylenic group may be used. Monomers of this kind can be used in special cases in order to achieve easy crosslinking of the polymers. The amount thereof should generally not exceed 2% by weight, preferably 1% by weight and especially 0.5% by weight, based on the sum total of all the monomers. More preferably, the monomers to be used in the present invention are only monoethylenically unsaturated monomers.

### Composition of the Polymers

The specific composition of the polymers may be selected according to the desired use of the polymers.

Preferred polymers are polyacrylamides and comprise, besides at least 10% by weight, preferably at least 20% by weight and for example at least 30% by weight of polyacrylamide, one further water-soluble, monoethylenically unsaturated monomer, preferably at least one further monomer selected from the group of acrylic acid or salts thereof, ATBS or salts thereof, associative monomers, in particular those of formula (V) or DMA3Q, more preferably at least further one monomer selected from acrylic acid or salts thereof, ATBS or salts thereof, associative monomers, in particular those of formula (V).

In one embodiment, polyacrylamides comprise 20% to 90% by weight of acrylamide and 10% to 80% by weight of acrylic acid and/or salts thereof, wherein the amounts of the monomers relate to the total of all monomers in the polymer.

In one embodiment, polyacrylamides comprise 20% to 40% by weight of acrylamide and 60% to 80% by weight of acrylic acid and/or salts thereof.

In one embodiment, polyacrylamides comprise 55% to 75% by weight of acrylamide and 25% to 45% by weight of acrylic acid and/or salts thereof.

In one embodiment, polyacrylamides comprise 45% to 75% by weight of acrylamide and 25% to 55% by weight of ATBS and/or salts thereof.

In one embodiment, polyacrylamides comprise 30% to 80% by weight of acrylamide, 10% to 40% by weight of acrylic acid and/or salts thereof, and 10% to 40% by weight of ATBS and/or salts thereof.

In one embodiment, polyacrylamides comprise 45% to 75% by weight of acrylamide, 0.1 to 5%, preferably 0.1 to 2% by weight of at least one associative monomer of the general formulas (I) or (II) mentioned above and 10 to 54.9% by weight of acrylic acid and/or ATBS and/or salts thereof. Preferably, the associative monomer(s) have the general formula (V) including the preferred embodiments mentioned above.

In one embodiment, polyacrylamides comprise 60% to 75% by weight of acrylamide, 0.1 to 5%, preferably 0.1 to 2% by weight of at least one associative monomer of the general formula (V) mentioned above, including the preferred embodiments, and 20 to 39.9% by weight of acrylic acid or salts thereof.

In one embodiment, polyacrylamides comprise 45% to 55% by weight of acrylamide, 0.1 to 5%, preferably 0.1 to 2% by weight of at least one associative monomer of the general formula (V) mentioned above, including the preferred embodiments, and 40 to 54.9% by weight of acrylic acid or salts thereof.

In one embodiment, the polyacrylamides comprise 60% to 99% by weight of acrylamide and 1% to 40% by weight of DMA3Q.

In one embodiment, the polyacrylamides comprise 10% to 50% by weight of acrylamide and 50% to 90% by weight of DMA3Q.

In one embodiment, the polyacrylamides comprise 90 to 99.5% by weight of acrylamide, 0.5 to 2% by weight of at least one associative monomer, and 0% to 9.5 % by weight of and anionic monomer, for example ATBS or a cationic monomer, for example DM3AQ. Preferably, the associative monomer(s) have the general formula (V) including the preferred embodiments mentioned above.

In all embodiments mentioned above, the amount of the monomers relates to the total of all monomers in the polymer. Further water-soluble, monoethylenically unsaturated monomers may be present besides those specifically mentioned, however, the embodiments each include also one embodiment in which besides the monomers specifically mentioned no further monomers are present, i.e. the total amount of the monomers specifically mentioned is 100% by weight.

The weight average molecular weight M_{w} of the polyacrylamides to be manufactured is selected by the skilled artisan according to the intended use of the polyacrylamides. For many applications high molecular weights are desirable. A high molecular weight corresponds to a high intrinsic viscosity (IV) of the polyacrylamides. In one embodiment of the invention, the intrinsic viscosity may be at least 15 deciliter/gram (dL/g). In one embodiment of the invention, the intrinsic viscosity is from 30 to 45 dl/g.

The numbers mentioned relate to the measurement with an automatic Lauda iVisc^{®} LMV830 equipped with an Ubbelohde capillary tube and automatic injection. For the measurements an aqueous solution of the polymers to be analyzed was prepared having a concentration of 250 ppm. The pH was adjusted at 7 by means of a buffer and the solution comprised additionally 1 mol /I of NaCl. Further four dilutions were done automatically. The viscosity at five different concentrations was measured at 25° C. with. The IV value [dL/g] was determined in usual manner by extrapolating the viscosities to infinite dilution. The error range is about +/- 2 dL/g.

### Step - Providing an Aqueous Polymer Gel

In course of step [1], an aqueous polymer gel comprising 15% to 45% by weight of a water-soluble polymer is provided, wherein the aqueous polymer gel is obtainable by polymerization of an aqueous solution comprising water-soluble, monoethylenically unsaturated monomers.

The concentration of the monomers in the aqueous monomer solution more or less corresponds to the polymer concentration in the aqueous polymer gel. In particular, the concentration of the monomers in the aqueous monomer solution is from 15% by weight to 45% by weight, wherein the percentages relate to the total of all components of all components of the aqueous monomer solution. Suitably the contents of monomer in the aqueous monomer solution may be from 20% to 45% by weight, desirably from 20% to 40% by weight, preferably from 20 to 35% by weight and for example from 20 to 25% by weight.

“Providing an aqueous polymer gel” shall mean that the aqueous polymer gel is available at the site at which the process according to the present invention is conducted. In one embodiment of the invention, the polymerization of the aqueous solution comprising monoethylenically unsaturated monomers may be conducted at the same site. In another embodiment of the invention, the polymerization may be conducted at another site and the aqueous polymer gel transported to the site the process according to the present invention is conducted. In this embodiment, suitably the polymerization may be carried out in a transportable polymerization unit. After polymerization, the polymerization unit filled with the aqueous polymer gel may be transported to another site at which the process according to the present invention is carried out.

Preferably, the aqueous monomer solution is polymerized under adiabatic conditions. Such a polymerization technique is also briefly denominated by the skilled artisan as “adiabatic gel polymerization”. Reactors for adiabatic gel polymerization are unstirred. Due to the relatively high monomer concentration the aqueous monomer solution used solidifies in course of polymerization thereby yielding an aqueous polymer gel.

“Adiabatic” is understood by the person skilled in the art to mean that there is no exchange of heat with the environment. This ideal is naturally difficult to achieve in practical chemical engineering. In the context of this invention, “adiabatic” shall consequently be understood to mean “essentially adiabatic”, meaning that the reactor is not supplied with any heat from the outside during the polymerization, i.e. is not heated, and the reactor is not cooled during the polymerization. However, it will be clear to the person skilled in the art that - according to the internal temperature of the reactor and the ambient temperature - certain amounts of heat can be released or absorbed via the reactor wall because of temperature gradients, but this effect naturally plays an ever lesser role with increasing reactor size. The polymerization of the aqueous monomer solution generates polymerization heat. Due to the adiabatic reaction conditions the temperature of the polymerization mixture increases in course of polymerization.

The polymerization of the aqueous monomer solution comprising monoethylenically unsaturated monomers is performed in the presence of suitable initiators for radical polymerization. Suitable initiators for radical polymerization, in particular adiabatic gel polymerization, are known to the skilled artisan. Before polymerization the aqueous monomer solution should be inerted in basically known manner.

In a preferred embodiment, redox initiators are used for initiating. Redox initiators can initiate a free-radical polymerization even at temperatures of less than +5° C. Examples of redox initiators are known to the skilled artisan and include systems based on Fe²⁺/Fe³⁺— H₂O₂, Fe²⁺/Fe³⁺ — alkyl hydroperoxides, alkyl hydroperoxides - sulfite, for example t-butyl hydroperoxide - sodium sulfite, peroxides - thiosulfate or alkyl hydroperoxides - sulfinates, for example alkyl hydroperoxides/ hydroxymethane-sulfinates, for example t-butyl hydroperoxide - sodium hydroxymethanesulfinate. Furthermore, water-soluble azo initiators may be used. The azo initiators are preferably fully water-soluble, but it is sufficient that they are soluble in the monomer solution in the desired amount. Examples of suitable azo initiators include 2,2′-azobis[2-(2-imidazolin-2-yl)propane] dihydrochloride, 2,2′-azobis(2-methylpropionamidine) dihydrochloride, 2,2′-azobis[N-(2-carboxyethyl)-2-methylpropionamidine hydrate, 2,2′-azobis{2-[1-(2-hydroxyethyl)-2-imidazolin-2-yl]propane} dihydrochloride, 2,2′-azobis(1 -imino-1-pyrrolidino-2-ethylpropane) dihydrochloride or azobis(isobutyronitrile).

In one embodiment of the invention a combination of at least one redox initiator and at least one azo initiator is used. The redox initiator efficiently starts polymerization already at temperatures below +5° C. When the reaction mixture heats up, also the azo initiators decompose and start polymerization.

Besides monomers and initiators, also additives and auxiliaries may be added to the aqueous monomer solution. Examples of such further additives and auxiliaries comprise bases or acids, complexing agents, defoamers, surfactants, or stabilizers.

Radical polymerization starts after adding the initiator solutions to the aqueous monomer solution thereby forming an aqueous polyacrylamide gel. Due to the polymerization heat generated in course of polymerization and the adiabatic reaction conditions, the temperature in the polymerization unit increases.

The temperature of the aqueous monomer solution before the onset of polymerization should not exceed 30° C. and preferably may be from -5° C. to +5° C. The temperature may rise to 50° C. to 95° C. in course of polymerization, for example to 55° C. to 70° C.

The polymerization may be performed in a polymerization unit having a volume of 1 m³ to 40 m³, preferably from 5 m³ to 40 m³, and for example 20 m³ to 30 m³. The polymerization unit may be a transportable polymerization unit which may be transported for instance by trucks or railcars.

The polymerization unit may be of cylindrical or conical shape. In one embodiment, the polymerization unit comprises a cylindrical upper part and a conical part at its lower end. At the lower end, there is a bottom opening which may be opened and closed. Besides the opening at its lower end the polymerization unit comprises one or more feeds for the aqueous monomer solution, initiator solutions, gases such as nitrogen or other additives. After polymerization, the polyacrylamide gel formed is removed through the opening, for example by means of gas pressure. Transportable polymerization units furthermore may comprise means such as legs or similar elements allowing to deploy the polymerization unit in a vertical manner. They may be transported in a horizontal manner.

### Step Comminuting and Mixing the Aqueous Polymer Gel With an Aqueous Liquid

In course of step [2] the aqueous polymer gel is comminuted and mixed with an aqueous liquid, thereby obtaining an aqueous mixture comprising an aqueous liquid comprising dissolved aqueous polymer and undissolved pieces of aqueous polymer gel.

In one embodiment, the aqueous liquid comprises water. The term “water” includes any kind of water such as desalinated water, fresh water or water comprising salts, such as brines, sea water, formation water, or mixtures thereof. Besides water, the aqueous liquid may comprise organic solvents miscible with water, however the amount of water relating to the total of the aqueous liquid should be at least 70% by weight, preferably at least 90% by weight, more preferably at least 95% by weight. In one preferred embodiment, the aqueous liquid comprises only water as solvent. Examples of organic solvents miscible with water comprise monohydric alcohols such as methanol, ethanol, n-propanol or i-propanol or polyhydric alcohols such as glycol, diethylene glycol or triethylene glycol. The aqueous liquid may optionally also comprise additives such as for example surfactants, complexing agents, bases, acids of the like. Kind and amount of such additives may be selected according to the intended use of the aqueous mixture.

In special cases, in another embodiment the term “aqueous liquid” may be understood as “hydrophilic liquid”, i.e. it does not comprise water but only comprises organic liquids, which are miscible with water. Examples of such solvents have already been mentioned above. Preferably, an aqueous liquid comprising water as detailed above, more preferably an aqueous liquid comprising only water as solvent may be used.

### Comminution Unit to Be Used

Step comprises is carried out by conveying the aqueous polymer gel through a comminution unit.

The comminution unit comprises at least
a flow chamber (3) comprising an inlet (5) and an outlet (6) for aqueous liquid,
a gel inlet (1) which is connected with the flow chamber (3),
a sheet-like molding tool (2), which separates the flow chamber (3) from the gel inlet (8), comprising a plurality of perforations (7) having a diameter d,
rotating cutting means (4) arranged within the flow chamber (3), wherein the distance between the cutting edge of the rotating cutting means and the surface of the sheet-like molding tool is ≤ mm,
a drive for rotating the cutting means (4), and
means for pressing aqueous polymer gel through the sheet-like molding tool (2).

A schematic drawing of one embodiment of the comminution unit to be used is shown in FIG. 1.

The flow chamber (3) represents the heart of the comminution unit. In operation, an aqueous liquid is flowing through the flow chamber. Aqueous gel is introduced into the flow chamber through a molding tool, the resultant gel stands cut by rotating cutting means arranged within the flow chamber and the obtained gel pieces are transported out of the flow chamber by means of the flow of an aqueous liquid.

The flow chamber (3) comprises an inlet (5) and an outlet (6) for aqueous liquid. In one embodiment which is shown in FIG. 1, the inlet (5) is arranged at the lower end of the flow chamber and the outlet (6) is arranged at the upper end, but of course also other arrangements are possible. The inlet (5) is connected with a source for aqueous liquid, for example a storage vessel for aqueous liquid. The connection may be a (flexible) pipe. Aqueous liquid may be removed from the storage tank and transported to the inlet (5) by means of a pump. The outlet (6) is connected with equipment for carrying out step [3] (such as for example a stirred or unstirred vessel), for example by means of a pipe. The pipe may comprise additional mixing elements, such as for example static mixers, for supporting mixing and dissolution.

The flow chamber furthermore is connected with a gel inlet (8). The gel inlet may for example be a pipe. The gel inlet (1) is separated from the flow chamber (3) by a sheet-like molding tool (2) comprising a plurality of perforations (7). Aqueous polymer gel (8) introduced into the gel inlet (1) passes through the perforations (7) into the flow chamber (3) thereby forming gel strands.

The comminution unit furthermore comprises means for pressing the aqueous polymer gel through the sheet-like molding tool (2) into the flow chamber (3). Examples of such means comprise a pump, for example a pump comprising a twin screw, a progressive cavity pump, a gear pump or an extruder. In one embodiment to the invention, a pump, preferably a pump selected from twin screw pumps, a progressive cavity pumps, and gear pumps is used.

The aqueous polymer gel may be provided in a vessel which is connected with the inlet of the means for pressing the aqueous polymer gel through the sheet-like molding tool for example by a pipe, and the aqueous polymer gel may be pressed from such vessel into the inlet by means of gas pressure, such as for example pressurized air.

The comminution unit furthermore comprises rotating cutting means (4), for example rotating knives arranged within the flow chamber (3) which cut the gel strands formed into pieces. The cutting means are connected to a rotatable axis. In one embodiment, cutting means such as knives are directly connected to the axis. Preferably a plurality of knives are connected to the axis. In other embodiments, the rotatable axis may be connected with a support, for example a circular disc to which the cutting means, for example knives are connected to. The distance between the cutting edge of the cutting means, for example the knives and the surface of the sheet-like molding tool (2) facing towards the flow chamber (3) preferably is ≤ 1 mm, for example ≤ 0.4 mm. In certain embodiments, the rotatable cutting means are in contact with the surface of the molding tool. The comminution unit furthermore comprises a drive for rotating the cutting means (4). The drive may be connected with the cutting means directly by an axis and the flow chamber (3) comprises a lead-through for the axis.

The flow chamber (3) basically may have any shape and size. Preferably, it should be as small as possible. Necessarily, it needs to be large enough to include the rotating cutting means. However, its dimensions should not exceed the diameter of the rotating cutting means too much. Such a construction ensures that there is still sufficient flow of the aqueous liquid in the flow chamber. Preferably, the flow chamber is cylindrical.

One preferred embodiment of a flow chamber (3) is shown in FIG. 2. The flow chamber (3) is cylindrical. The inlet (5) for aqueous liquid is arranged at the lower side of the lateral surface cylinder of the cylinder and the outlet (6) for aqueous liquid at the upper side of the lateral surface. The outlet (6) and the inlet (5) may be opposite to each other as shown in FIG. 2, but of course other arrangements are possible. The gel inlet (1) is arranged at the rear base of the cylinder and the axis for the rotational cutting means (4) is lead through the front base of the cylinder. Preferably, the proportion x/y of the diameter x of the cylindrical flow chamber and the diameter of the rotational cutting means shall be from 1.1 to 2.

Aqueous polymer gel (8) introduced into the gel inlet (1) needs to pass through the perforations (7) of the sheet-like molding tool (2) thereby forming gel strands.

The term “sheet-like” shall mean that the thickness of the molding tool is less than its diameter. It may be plate-like, i.e. having even surfaces, but it may also not have an even surface. The sheet-like molding tool (2) separates the gel inlet (1) from the flow chamber (3). Its contour fits to the shape of the gel inlet (1). For the typical case that the gel inlet is a pipe, the sheet-like molding tool (2) is circular.

The shape of the perforations in the molding tool is not specifically limited. Examples comprise perforations of circular, ellipsoidal, triangular or quadrangular shape such as quadratic, rectangular, or rhombic perforations, perforations of pentagonal, hexagonal or star-like shape but also longitudinal perforations such as slots. The perforations may be cylindrical, but they may also be conical. Preferably, the perforations are circular. The diameter d of the perforations (7) preferably is from 1 to 10 mm, in particular from 2 to 10 mm, for example from 3 mm to 8 mm. For non-circular perforations, the term “diameter” relates to the longest dimension of the respective perforation. In case of conical perforations, the diameter is measured on the side of the molding-tool facing towards the flow chamber. In one embodiment of the invention, the perforations (7) are circular, having a diameter from 2 to 10 mm, for example from 3 mm to 8 mm or from 4 to 6 mm.

The sheet-like molding tool (2) comprises a plurality of perforations. The number of perforations may be selected by the skilled artisan according to his/her needs.

In one embodiment, the perforations are distributed over the entire area of the sheet-like molding tool (2), preferably a plate-like molding tool. Such a construction results in a non-uniform particle size distribution of the gel particles generated because the velocity at which gel exits from the perforations (7) is more or less constant for all perforations, while the effective velocity of the rotating cutting means is lower in the regions close to the center and higher in the regions more distant from the center.

In a preferred embodiment, the perforations (7) are arranged such that the perforations are at equal distances from the center of the sheet-like molding tool (2). In such an embodiment, the effective velocity of the knives is the same for each of the perforations is the same and therefore, a more even distribution of gel particles results. Such an arrangement of perforations is schematically shown in FIG. 3 (view from above). Preferably, the perforations are arranged as in the outer sections of the molding tool. For a circular molding tool having a radius of k, the distance of the centers of the perforations from the center of the molding tool should be at least 0.5 \*k the center, for example from 0.5 \*k to 0.9 \*k.

Of course, other arrangements of the perforations are possible, such as arranging all perforations in a specific annular section of the circular molding tool.

FIG. 4 schematically shows a profile view of a sheet-like molding tool (2) in which the perforations (7) are arranged at equal distances from its center. The rotating cutting means (4) comprise a plurality of knives (9).

FIG. 5 schematically shows another embodiment of rotating cutting means (4). The rotating cutting means (4) comprise a support (10), for example a circular disc to which a plurality of knives (11) are connected. Preferably, the knives are bent towards the direction of rotation. The dispersion of the cut slices in the aqueous liquid can be supported by a displacement device which covers the center of the molding tool. Such an embodiment is shown in FIG. 6.

In one embodiment of the invention, the comminution unit may be connected directly with the polymerization unit. For that purpose, an opening, preferably a bottom opening in the polymerization unit may be connected with the pump and the aqueous polymer gel may the transferred directly through the opening in the polymerization unit into the gel inlet (8) of the comminution unit. Removing the aqueous polymer gel from the reactor may be supported in known manner by means of pressure onto the gel, in particular by means of gas pressure.

### Operation of the Comminution Unit

The comminution unit as described above is used for comminuting and mixing the aqueous polymer gel with an aqueous liquid. The operation of the comminution unit is shown schematically in FIG. 7.

For carrying out the process according to the present invention, a stream of an aqueous liquid is introduced into the flow chamber (3) through the inlet (5) and it leaves the flow chamber through the outlet (6).

The aqueous polymer gel is introduced into the gel inlet (8) at a pressure sufficient to pass through the perforations (7) of the sheet-like molding tool (2), thereby forming polymer gel strands. The pressure to be applied may be selected by the skilled artisan and may be for example up to 25*10⁵ Pa.

The polymer gel strands formed as mentioned above are cut by the rotating cutting means into gel pieces and the pieces are dispersed in the aqueous liquid flowing through the flow chamber. The process of dispersing is supported by the cutting means rotating in the flow chamber (3). While the product obtained mainly is a dispersion of gel pieces in the aqueous liquid, inevitably already a certain amount of the water-soluble polymer dissolves in the aqueous liquid already in the flow chamber (3). As will be shown in the experimental part, the amounts already dissolved in the flow-chamber may be significant. The product obtained is thus an aqueous mixture comprising an aqueous liquid comprising dissolved aqueous polymer and undissolved aqueous polymer gel pieces.

In the process according to the present invention, the rotational speed of the cutting means (4) and the speed of the polymer gel strands exiting through the perforations (7) is adjusted such that the polymer gel strands are cut into slices having a thickness s, wherein s/d < 1, for example from 0.01 to 0.9. d is the diameter polymer gel strands which corresponds to the diameter of the perforations (7). In one embodiment of the invention, s/d is in the range from 0.01 to 0.1. Cutting the strands into slices generates a large surface area which supports quick dissolution and significantly eases homogenization in the following step [3] and ensures a quick formation of the aqueous polymer composition.

The aqueous mixture comprising an aqueous liquid comprising dissolved aqueous polymer and undissolved aqueous polymer gel pieces is removed from the flow chamber (3) through the outlet (6) as a continuous stream.

In order to ensure a good transport of the aqueous gel particles, the flow of the aqueous liquid flowing into the inlet (5) is adjusted such that the resultant aqueous liquid comprising dissolved aqueous polymer and undissolved aqueous polymer gel pieces existing through the outlet (6) is turbulent.

The total amount of aqueous liquid used in course of step [2] may be adjusted by the skilled artisan. Naturally, there is an upper limit for the amount of water used which depends on the desired concentration of the final product, which has a polymer concentration of less than 15% by weight, relating to the total of all components.

In one embodiment of the invention, already in course of step of step [2] the entire amount of aqueous liquid necessary to achieve the desired final concentration is added.

In other embodiments, only a part the aqueous liquid necessary to achieve the desired final concentration is added and the remainder in course of step [3]. However, as a rule, at least 30% by wt. of the total amount of water necessary should be added already in course of step [2], for example from 30% by wt. to 99% by wt., from 50% by wt. to 99% by wt., or from 80% to 99% by wt..

### Step Homogenization

In course of step [3], the aqueous mixture obtained in course of step [2] is homogenized, thereby obtaining an aqueous polymer composition comprising at least an aqueous liquid and water-soluble polymer, wherein the concentration of the polymer is less than 15% by weight, relating to the total of all components of the aqueous polymer composition.

Depending on parameters such as the chemical composition, the molecular weight and the concentration, the aqueous polymer composition may be a solution or a (soft) solid. In general, the concentrate is pumpable. In general, the concentration of the aqueous polymer composition may be from 0.01% to less than 15% by wt., preferably from 0.01% to less than 10% by wt..

In one embodiment of the invention, the aqueous polymer composition is an aqueous polymer solution comprising 0.01% to 2% by wt. of polymers, relating to the total of all components of the aqueous polymer solution. Preferably, the amount is from 0.1% to 1 % by wt..

In another embodiment of the invention, the aqueous polymer composition is an aqueous polymer concentrate comprising 2.1% to 14.9% by wt. of polymers, relating to the total of all components of the aqueous polymer concentrate, for example from 3.1% to 14.9% by weight, in particular from 3.1% by weight to 10% by weight, preferably 3.1% by weight to 7% by weight, for example from 4% by weight to 6% by weight.

In course of the homogenization step [3] ideally, a homogeneous mixture of polyacrylamides and aqueous liquid should be obtained, i.e. a (solid) solution. However, the invention shall not be limited to such an embodiment and shall encompass also aqueous polymer composition which are not absolutely homogeneous.

If not already done, any remaining amount of aqueous liquid to achieve the desired concentration of the aqueous polyacrylamide concentrate -if any- is added in course of step [3].

In one embodiment of the invention, the step [3] may be carried out by simply allowing the mixture obtained in course of step [2] to stand in a suitable vessel in order to homogenize without mixing. The time, the mixture is allowed to stand may be from minutes to several hours, for example from 5 min to 1 day, in particular from 1 h to 12 h. Of course, also longer times may be chosen.

Surprisingly, simply allowing the mixture to stand is sufficient for obtaining the desired aqueous polymer composition. Cutting the gel strands into slices as outlined above generates particles having a high specific surface which support rapid dissolution. Already a significant amount of the aqueous polymer gel already dissolves in the flow chamber and when the mixture is transported through the pipe to the product vessel, so that a mixture of aqueous polymer gel particles in an aqueous solution of the polymer is obtained which already has a significant viscosity. Consequently, the aqueous polymer gel particles don’t sediment but remain dispersed in the aqueous phase. If no slices are cut, the particles start to sediment and cannot be homogenized by simply allowing to stand.

Step may be carried out as separate step, but it may also be combined with other process steps.

In one embodiment of the invention, the process comprises an additional step [4] of transporting the aqueous polymer composition from the production site to another site in a suitable transport unit. If such a transport step [4] follows, step [3] advantageously may be carried out by filling the mixture obtained in course of step [2] into the transport unit used for step [4]. Advantageously, in this embodiment, the transport time may be used for homogenization.

In other embodiments, the mixture obtained in course of step [2] may be further mixed using suitable means. If the aqueous polyacrylamide composition has a viscosity which is not too high so that stirring is possible, a stirred vessel may be used for homogenization. Naturally, such an embodiment is suitable in particular for more dilute compositions, such as the aqueous polymer solutions comprising 0.01% to 2% by wt. of polymers as mentioned above.

Other embodiments include the use of static mixers. In one embodiment, the mixture may be circulated using circulation pumps. Optionally, the loop may comprise one or more static mixers. Further examples include tumbling, shaking or any mixing method known to skilled in the art for highly viscous liquids, for example using progressive cavity pumps. In one embodiment, the mixture obtained in course of step [2] in homogenized by filling it into a vessel which is equipped with a mixing loop which may comprise one to more than one static mixers. The loop rate may be from 10 to 100% of the storage tank volume per hour, for example from more 20 to 40%.

In case a transport step [4] follows, in one embodiment the transport unit, for example a truck may comprise a rotating drum. Trucks comprising rotating drums are known on the art for transporting concrete. Homogenization may be effected in course of transport by rotating the drum.

### Optional Further Steps

The process according to the present invention may optionally comprise further process step.

In one embodiment of the invention, the process comprises an additional step [4] of transporting the aqueous polymer composition from a location A to a location B.

Location A is a location, at which the aqueous polymer compositions are manufactured. The plant for carrying out the process may be a fixed plant, but is also may be a relocatable, modular plant which may be erected at a location close to the users of the aqueous polymer composition, i.e. on an oilfield or close to an oilfield.

Locations B are the site-of-use for the aqueous polymer composition, for example at an oil well.

Transport may be effected by pumping the aqueous polymer composition through a pipeline from location A to location B. The pipeline may comprise a series of pumps for maintaining the pressure. Pipeline transport is in particular suitable, if the aqueous polymer composition is an aqueous polymer solution comprising 0.01% to 2% by wt. of polymers. Preferred embodiments have already been disclosed above.

In another embodiment, the transport is carried out, by filling the aqueous polymer composition into a suitable transport unit and transporting the transport unit from location A to location B. Transport in a transport unit is in particular suitable, if the aqueous polymer composition is an aqueous polymer concentrate comprising 2.1% to 14.9% by wt. of polymers. Preferred embodiments have already been disclosed above.

The transport unit may have a volume from 1 m³ to 40 m³, in particular 5 m³ to 40 m³, for example 20 m³ to 30 m³. Examples of suitable transport units comprise vessels comprising at least one opening, tank containers, or tipping vessels.

The transport may be carried out by any transport means suitable for transporting the transport unit, for example by trucks, railcars or ships. In one embodiment, the transport is carried out by trucks. The transport unit may also be fixed on a truck.

In one embodiment, the transport unit may be an ISO tank container. Typical dimensions of ISO containers have already been mentioned above.

In another embodiment, tanks fixed on a truck may be used. In one embodiment, the tank comprises an outlet opening at the rear end of the truck and for supporting removal of the contents the tank may be tilted. In another embodiment, the tank comprises an outlet opening at the bottom side of the tank. Additionally, the tank may comprise a conus at the bottom side of the tank and the outlet opening in located at the lower end of the conus. The tank may also be rotatable, so that the concentrate may become homogenized in course of transport. For example, a concrete mixer may be used for transporting the concentrate.

Filling the transport unit with the aqueous polyacrylamide concentrate may be carried out by pumping the concentrate into the transport unit.

The transport time, i.e. the time for transporting the transport unit filled with aqueous polyacrylamide concentrate may be very different, depending on the distance between the locations A and B. It may range from minutes to several days, for example from 1 h to 28 days, in particular from 2 hours to 14 days, in particular 5 hours to 7 days.

### Use of the Aqueous Polymer Solutions

The aqueous polymer solutions manufactured according to the present invention, preferably the aqueous polyacrylamide solutions, may be used for various purposes, for example for mining applications, oilfield applications, water treatment, waste-water cleanup, paper making or agricultural applications.

For the application, the aqueous polymer solutions, preferably the aqueous polyacrylamide solutions may be used as such or they may be formulated with further components. The specific composition of aqueous polymer solutions is selected by the skilled artisan according to the intended use of the polymer solution.

### Advantages of the Process According to the Invention

The present invention provides an advantageous process for providing aqueous polymer compositions. The used comminution unit is a very compact one, and therefore particularly suitable for relocatable plants. Cutting the gel stands into slices significantly eases the process of obtaining a homogeneous aqueous polymer composition.

The following examples are deemed to further illustrate the invention:
Test methods
Solids content measurement

The solids content of the gel is measured using the oven method. Therefore, defined pieces of gel were weighed on aluminium plates in triplicates and dried at 110° C. for 12 h. In contrast to the theoretical value, the measured value was always about 2% higher due to residual water captured in the polymer.

### Composition of pH 7 Buffer

A 5 L volumetric flask is charged with 583.3 ± 0.1 g sodium chloride, 161.3 ± 0.1 g disodium hydrogenphosphate • 12 H₂O, 7.80 ± 0.01 g sodium dihydrogenphosphate · 2 H₂O and 4 L of distilled water. The solution is stirred until full dissolution and filled up to the 5 L graduation mark with distilled water. The pH value should be 7.0 ± 0.1. The concentrated pH 7 buffer^{2*} solution was diluted 1 : 1 with distilled water to obtain the pH 7 buffer.

### Measurement of Brookfield RS Viscosity

A 5000 ppm solution of the water-soluble polymer was used. The viscosity was measured at room temperature with a Brookfield R/S device equipped with a 45 mm bob and cup geometry at a shear rate of 100 s⁻¹. An average value is taken after 3 minutes of measurement. Error range: ± 5 mPas.

### Measurement of Brookfield RV Viscosity

The viscosity of the mixtures obtained from the comminution unit was measured at room temperature with a Brookfield RV/DV-II+PX device equipped with a corresponding spindle at a shear rate of 5 rpm. The value is taken after 1 minute of measurement. Different spindles were used according to the viscosity (RV2 < 5000 mPas, RV3 < 20000 mPas, RV4 < 30000 mPas, RV5 < 40000 mPas, RV6 < 110000 mPas, RV7 > 110000 mPas). Error range: ± 5%

### Measurement of Intrinsic Viscosity

The polymer solution was diluted to 350 ppm with pH 7 buffer and injected. Further four dilutions were done automatically. The viscosity at five different concentrations was measured at 25° C. with an automatic Lauda iVisc LMV830 equipped with an Ubbelohde capillary tube and manual injection. The IV value [dL/g] was taken at infinite dilution. For single point measurements, the value was only measured once at a concentration of 350 ppm. Error range: ± 2 dL/g

### Aqueous Polymer Gel

For the tests an aqueous polymer gel comprising a copolymer of 75 mol-% of acrylamide and 25 mol-% of sodium acrylate was synthesized by adiabatic gel polymerization. The solids content of the aqueous gel was 23 wt.-% relating to the total of the aqueous polymer gel.

The following procedure represents a lab synthesis in 3.5 kg scale, but the synthesis can be carried out in the same manner in pilot scale (e.g. in 300 kg scale) or in production scale (e.g. in 20,000 kg scale).

A 5 L beaker with magnetic stirrer, pH meter and thermometer was charged with 1600 g of distilled water, 702 g of sodium acrylate (35% by weight in water), and 1071.7 g of acrylamide (52% by weight in water). Then 10.5 g of diethylenetriaminepentaacetic acid pentasodium salt (Trilon® C; 5% by weight in water), and 4 g of the stabilizer sodium 2-mercaptobenzothiazole (Na-MBT; 50% by weight in water) were added.

After adjustment to pH 6.4 with sulfuric acid (20% by weight in water) and addition of the rest of the water to attain the desired monomer concentration of 23% by weight (total amount of water 1690 g minus the amount of water already added, minus the amount of acid required), the monomer solution was adjusted to a temperature of approx. -3° C. The solution was transferred to a Dewar vessel, the sensor for the temperature recording was inserted, and the flask was purged with nitrogen for 45 minutes. The polymerization was initiated at 0° C. with 21 g of a 10% aqueous solution of 2,2′-azobis(2-methylpropionamidine) dihydrochloride (Wako V-50; 10 h t_{½} in water 56° C.), 1.75 g of t-butyl hydroperoxide (1% by weight in water) and 1.05 g of a 1% sodium sulfite solution. With the onset of the polymerization, the temperature rose to >60° C. within about 60 min. A solid polymer gel block was obtained. After polymerization, the gel block was incubated 4 hours at 60° C. The block was cut into larger pieces and sealed in plastic bags until further testing.

### Comminution Unit

For the tests a commercially available device for underwater granulation of thermoplastic polymers was used which was adapted for use in the present invention.

FIG. 8 shows a front view of the opened flow chamber (3) comprising an inlet (5) and an outlet (6) for aqueous liquid. The flow chamber is circular and has a diameter of about 35 cm, the inlet line and the outlet line have a diameter of about 8 cm each. At the rear side of the flow chamber a sheet-like molding tool (2) is located which comprises a plurality of circular perforations (7) which are arranged circle-like.The number and the diameter of perforations were varied in course of the tests. Details are provided in the tables which follow. The aqueous polymer gel is pressed from the rear side through the sheet-like molding tool.

Two different devices were used for pressing the aqueous polymer gel through the sheet-like molding tool:

In a first embodiment, the comminution unit is equipped with a twin-screw extruder and the aqueous polymer gel is fed manually into the feed hopper of the twin-screw extruder. This is basically the set-up for the known use of the device for granulating thermoplastic polymers.

In a second embodiment, the comminution unit is adapted for comminuting aqueous polymer gels. The comminution unit is equipped with a double-screw pump instead of the double-screw extruder. The inlet of the double-srew pump is connected with a vessel comprising the aqueous polymer gel. In operation, the aqueous polymer gel can be pressed by means of pressurized air from the vessel into the inlet of the double-screw pump which presses the gel through the sheet-like molding tool (2) into the flow-chamber (3).

FIG. 9 shows the flow-chamber (3) with the rotating cutting means (4). A plurality of knives (9) is fixed to a rotating axis. Cutting means comprising 8 or 12 knives were used. The outer diameter of the rotating cutting means is about 34.5 cm. In operation, the rotating cutting means is placed in the flow chamber and the open side is closed by a front plate which comprises a water-tight lead-through for the rotating axis. The thickness of the pieces of the aqueous polymer gel is determined by the velocity of the flow of gel through the perforations

The aqueous liquid enters into the flow chamber through the inlet (5) and a mixture of a solution of the water-soluble polymer in an aqueous liquid and undissolved gel pieces leaves the flow chamber through the outlet (6). The outlet is connected with a product vessel by a pipe. In the product vessel, the homogenization step [3] is carried out simply by allowing the mixture to stand. The pipe comprises a sampling point which may be used for withdrawing tests samples of the mixture streaming through the pipe.

### Comminution Tests

### Two Series of Tests Were Carried Out

In a first test series (examples 1 - 5), a comminution unit according to the first embodiment as described above was used, i.e. a comminution unit equipped with a double-screw extruder which was fed manually. For the tests tap water of ambient temperatures was used for dissolving the aqueous polymer gel. In course of the tests the size and the number of perforations in the sheet-like molding tool, the flow of gel and the flow of water were varied. The detailed operational parameters of examples 1 to 5 are provided in table 1 which follows.

Each of the tests yielded a mixture of pieces of aqueous polymer gel in an aqueous solution of the water-soluble polymer which was allowed to stand in the vessel for homogenization.

In a second test series (examples 6 to 12), a comminution unit according to the second embodiment as described was used, i.e. a comminution unit comprising a double-screw pump and a gel vessel feeding the pump. The detailed operational parameters of the tests are provided in table 2 which follows.

The properties of the mixtures obtained were evaluated according to the following methods:

### Time Dependent Viscosity Measurements

The dissolution of the aqueous polymer gel was monitored by the measurement of the Brookfield RV viscosity of the mixture obtained as a function of time. The higher the viscosity, the more aqueous polymer gel has been dissolved. Finally, the viscosity does no longer increase but reaches a plateau which indicates full dissolution. For the measurement, test samples were taken from the product pipe as indicated above and allowed to rest. The viscosity was measured a first time immediately after taking the sample and thereafter measurements were carried out at different times.

The development of the viscosity as a function of time for examples 1 to 5 is shown in table 3 and graphically represented in FIG. 11, and for examples 6 to 12 in table 4 and in FIG. 10.

TABLE 1

Operational parameter of tests series 1

| | | | | | | |
|---|---|---|---|---|---|---|
| Example No. | | 1 | 2 | 3 | 4 | 5 |
| Flow of gel into flow chamber | kg/h Gel (23%) | 274 | 121 | 164 | 453 | 615 |
| Flow of water through flow chamber | kg/h | 2000 | 2000 | 2000 | 3000 | 3000 |
| Pressure of gel | bar | 20 | 35 | 23 | 17 | 21 |
| Number of circular perforations | | 10 | 30 | 20 | 30 | 20 |
| Diameter of perforations d | mm | 4,5 | 2 | 3,2 | 4,5 | 4,5 |
| Number of knives | | 12 | 12 | 12 | 12 | 12 |
| Rotational speed of cutting means | rpm | 2000 | 2000 | 2000 | 2000 | 2000 |
| Amount of gel per perforation | kg/h | 27,40 | 4,03 | 8,18 | 15,09 | 30,73 |
| Flow velocity of gel through perforations | m/s | 0,48 | 0,36 | 0,28 | 0,26 | 0,54 |
| Mass per gel piece | g | 0,019 | 0,003 | 0,006 | 0,010 | 0,021 |
| Thickness of pieces s | mm | 0,30 | 0,22 | 0,18 | 0,16 | 0,34 |
| Thickness/diameter ratio s/d | | 0,07 | 0,11 | 0,06 | 0,04 | 0,07 |
| Measured polymer concentration after dissolution | wt% | 2,85 | 1,33 | 1,77 | 3,11 | 4,07 |

TABLE 2

Operational parameter of tests series 2

| | | | | | | | | |
|---|---|---|---|---|---|---|---|---|
| Example No. | | 6 | 7 | 8 | 9 | 10 | 11 | 12 |
| Flow of gel into flow chamber | kg/h Gel (23%) | 500 | 510 | 801 | 1050 | 1105 | 427 | 506 |
| Flow of water through flow chamber | kg/h | 3000 | 2000 | 4000 | 3000 | 3000 | 3000 | 2000 |
| Number of circular perforations | | 80 | 80 | 80 | 80 | 80 | 80 | 80 |
| Diameter of perforations d | mm | 4,2 | 4,2 | 4,2 | 4,2 | 4,2 | 4,2 | 4,2 |
| Number of knives | | 8 | 8 | 8 | 8 | 8 | 8 | 8 |
| Rotational speed of cutting means | rpm | 1500 | 1500 | 2500 | 2500 | 2000 | 2500 | 3300 |
| Amount of gel per perforation | kg/h | 6,26 | 6,37 | 10,01 | 13,12 | 13,81 | 5,34 | 6,32 |
| Flow velocity of gel through perforations | m/s | 0,13 | 0,13 | 0,20 | 0,26 | 0,28 | 0,11 | 0,13 |
| Mass per gel piece | g | 0,008 | 0,011 | 0,014 | 0,004 | 0,004 | 0,008 | 0,011 |
| Thickness of pieces s | mm | 0,16 | 0,16 | 0,15 | 0,20 | 0,26 | 0,08 | 0,07 |
| Thickness/diameter ration s/d | | 0,04 | 0,04 | 0,04 | 0,05 | 0,06 | 0,02 | 0,02 |
| Measured polymer concentration after dissolution | wt.-% | 3,4 | 4,9 | 3,99 | 6,34 | 6,6 | 2,95 | 4,87 |

TABLE 3

Viscosity of the mixture obtained in examples 1 to 5 as a function of time (in brackets: % of final viscosity)
Brookfield RV viscosity

| Example No. | 1 | 2 | 3 | 4 | 5 |
|---|---|---|---|---|---|
| min | | | | | |
| 0 | 12000 (10.5%) | 2000 (4.5%) | 28480 (33.9%) | 109000 (62.6%) | 92000 (41.6%) |
| 30 | 60000 | | | 178000 | 229000 |
| 60 | 92000 | | 48800 | | |
| 90 | 107000 | | | | |
| 120 | 102000 | 28160 | | | |
| 150 | | | | | 226000 |
| 180 | | | | 178000 | |
| 210 | | | | | |
| 240 | 113000 | | | | |
| 270 | | | | | |
| 300 | | | | | |
| 330 | | 31400 | | | |
| 360 | | | | | |
| 390 | | | | | |
| 420 | 114000 | | | | |
| 1200 | | | 84000 | 174000 | |
| 1230 | | | | | |
| 1260 | | | | | 221000 |
| 1290 | | | | | |
| 1320 | | 44800 | | | |
| 1350 | | | | | |
| 1380 | | | | | |
| 1410 | | | | | |
| 1440 | 114000 | | | | |

TABLE 4

Viscosity of the mixture obtained in examples 6 to 8, 11 and 12 as a function of time
Brookfield RV viscosity

| Example No. | 6 | 7 | 8 | 10 | 11 |
|---|---|---|---|---|---|
| min | | | | | |
| 0 | 73600 (43.2%) | 57000 (19.5%) | 41000 (22.5%) | 152000 (31.4%) | 14600 (18.5%) |
| 2 | | | 86400 | | |
| 5 | | 111000 | 142000 | 262000 | 23000 |
| 10 | | | 132000 | 310000 | 40800 |
| 15 | 83300 | | | 350000 | 43200 |
| 20 | 110000 | 166000 | | 436000 | 51800 |
| 25 | | 158000 | | 470000 | 48700 |
| 30 | 110500 | | 154000 | 451000 | 64200 |
| 35 | | | | 468000 | 59200 |
| 40 | 132000 | 175000 | | | |
| 45 | | | | 462000 | 62400 |
| 50 | | | 160500 | | |
| 55 | | | | | |
| 60 | | | | 492000 | 71000 |
| 65 | | | | | |
| 70 | | | | | |
| 75 | | | | 506500 | 72267 |
| 80 | | | 184000 | | |
| 85 | | | | | |
| 90 | | | | 482333 | 67267 |
| 95 | | | | | |
| 100 | | 232500 | 166500 | | |
| 105 | | | | | |
| 110 | | | | | |
| 115 | | | | | |
| 120 | 160000 | 241000 | | 481000 | 67200 |
| 180 | 151500 | | | | 72267 |
| 185 | | | | | |
| 190 | | | | | |
| 195 | | | | | |
| 200 | 170500 | 292500 | 182000 | 483333 | 78800 |

TABLE 5

Results of viscosity measurements

| Example No. | Perforations | | Amount of gel per perforation [kg/h] | Flow velocity of gel through perforation [m/s] | Amount of solids | Brookfield RV viscosity [mPa*s] | Brookfield RS viscosity [mPa*s] | Intrinsic viscosity [dl/g] |
|---|---|---|---|---|---|---|---|---|
| | No. | Diameter [mm] | | | | | | |
| 1 | 10 | 4.5 | 27.4 | 0.48 | 2.62 % | 114000 | 59 | 28 |
| 5 | 20 | 4.5 | 30.7 | 0.54 | 4.08 % | 221000 | 59 | 30 |
| 4 | 30 | 4.5 | 15.1 | 0.26 | 3.21 % | 174000 | 58 | 27 |
| 3 | 20 | 3.2 | 8.2 | 0.28 | 1.86 % | 84000 | 61 | 27 |
| 2 | 30 | 2 | 4.0 | 0.36 | 1.36 % | 44800 | 50 | 25 |

*Aqueous polymer gel before processing

### Comments on the Results

In the method according to the present invention, the aqueous polymer gel strands passing through the perforations are cut into slices. In the experiments, the thickness / diameter ratio s/d is significantly below 1 (all tests yielded values in the range from 0.02 to 1.1). So, the aqueous polymer gel pieces have a high surface to volume ratio and therefore dissolve very quickly. A significant amount of the aqueous polymer already dissolves in the mixing chamber and the pipe connecting the mixing chamber with the product vessel. This can be clearly derived from the viscosity measurements in tables 3 and 4 and FIGS. 10 and 11. In all of the examples, already the initial viscosities at t=0 are significant (the lowest number is 2,000 mPa*s, others are well above 10,000 ppm, for comparison: the viscosity of water at ambient temperatures is about 1 mPa*s). In examples 1 to 4, the initial viscosity is in the range from about 10 to 60% of the final viscosity, and in examples 6 to 8, 10 and 11, the initial viscosity is in the range from about 20 to 40% of the final viscosity. Due to the high specific surface of the gel particles and the high initial viscosity, the gel particles don’t set when resting in the product vessel, so that the final dissolution can be achieved by simply allowing the mixture of gel pieces in an aqueous solution of the water-soluble polymer to stand. Stirring is not necessary which allows a simple construction.

Nevertheless, the dissolution is quickly. In test series 2, the final viscosities in nearly all cases were reached after about 60 min.

If not slices are cut but shorts strands, i.e. s/d > 0, the particles sediment if the mixture in the product vessel is not stirred and therefore don’t dissolve fast.

The data in table 5 furthermore help to choose good operating parameters for the process. The number of perforations in the sheet-like molding tool as well as their diameter was varied. Example No. 2, in which perforations having only 2 mm diameter were used, shows -as compared to the other tests using 3.2 and 4.5 mm perforations-a slightly decreased Brookfield RS number (all of which were measured at a concentration of 5,000 ppm) and a slightly decreased intrinsic viscosity. Said result indicates beginning damaging of the polymer under the conditions chosen.

1-25. (canceled)

26. A process for providing aqueous polymer compositions comprising at least the steps of
[1] providing an aqueous polymer gel comprising 15% to 45% by weight of a water-soluble polymer obtainable by polymerization of an aqueous solution comprising water-soluble, monoethylenically unsaturated monomers,
[2] comminuting and mixing the aqueous polymer gel with an aqueous liquid, wherein step [2] comprises conveying the aqueous polymer gel through a comminution unit, comprising at least
a flow chamber comprising an inlet and an outlet for aqueous liquid,
a gel inlet which is connected with the flow chamber,
a sheet-like molding tool, which separates the flow chamber from the gel inlet, comprising a plurality of perforations having a diameter d,
rotating cutting means arranged within the flow chamber, wherein the distance between the cutting edge of the rotating cutting means and the surface of the sheet-like molding tool is ≤ 1 mm,
a drive for rotating the cutting means,
means for pressing aqueous polymer gel through the sheet-like molding tool, wherein
the aqueous polymer gel is introduced into the gel inlet at a pressure sufficient to pass through the perforations of the sheet-like molding tool, thereby forming polymer gel strands,
a stream of an aqueous liquid is introduced into the flow chamber through the inlet,
the polymer gel strands are cut by the rotating cutting means, wherein the rotational speed of the cutting means and the speed of the polymer gel strands exiting through the perforations is adjusted in such a manner, that the polymer gel strands are cut into slices having a thickness s, wherein s/d < 1, and the slices are dispersed in the aqueous liquid, thereby obtaining an aqueous mixture comprising an aqueous liquid comprising dissolved aqueous polymer and undissolved aqueous polymer gel, and
a stream of an aqueous mixture comprising an aqueous liquid comprising dissolved aqueous polymer and undissolved aqueous polymer gel is removed from the flow chamber through the outlet, and
[3] homogenizing the aqueous mixture obtained in course of step [2], thereby obtaining an aqueous polymer composition comprising at least an aqueous liquid and water-soluble polymer, wherein the concentration of the polymer is less than 15% by weight, relating to the total of all components of the aqueous polymer composition.

27. The process according to claim 26, wherein the flow chamber is cylindrical and the inlet for aqueous liquid is arranged at the lower side of the lateral surface of the cylinder and the outlet for aqueous liquid at the upper side of the lateral surface.

28. The process according to claim 27, wherein the gel inlet is arranged at the rear base of the cylinder and the axis for the rotational cutting means is lead through the front base of the cylinder.

29. The process according to claim 27, wherein the proportion x/y of the diameter x of the cylindrical flow chamber and the diameter of the rotational cutting means is from 1.1 to 2.

30. The process according to claim 26, wherein the perforations are circular having a diameter from 2 mm to 6 mm.

31. The process according to claim 26, wherein the perforations are arranged at equal distances from the center of the sheet-like molding tool.

32. The process according to claim 26, wherein the cutting means comprise cutting a plurality of blades.

33. The process according to claim 26, wherein the cutting means comprise a rotating support to which a plurality of knives are connected.

34. The process according to claim 26, wherein, the aqueous polymer gel is introduced into the gel inlet by means of a pump.

35. The process according to claim 34, wherein the pump comprises a twin screw.

36. The process according to claim 26, wherein the flow of the aqueous liquid flowing into the inlet is adjusted such that the resultant aqueous liquid comprising dissolved aqueous polymer and undissolved aqueous polymer gel pieces exiting through the outlet is turbulent.

37. The process according to claim 26, wherein the entire amount of aqueous liquid necessary to achieve the final concentration is added in course of step [2].

38. The process according to claim 26, wherein only a part of the amount of aqueous liquid necessary to achieve the final concentration is added in course of step [2] and the remainder in course of step [3].

39. The process according to claim 26, wherein the homogenization step [3] is carried out by allowing the mixture obtained in course of step [2] to stand in a vessel.

40. The process according to claim 26, wherein the homogenization step [3] is carried out by stirring the mixture obtained in course of step [2] in a vessel.

41. The process according to claim 26, wherein the homogenization step [3] is carried out by pumping the mixture obtained in course of step [2] through a static mixer.

42. The process according to claim 26, wherein the aqueous polymer gel comprises from 20% by wt. to 45% by wt. of water-soluble polymers.

43. The process according to claim 26, wherein the aqueous polymer composition is an aqueous polymer solution comprising 0.01% to 2% by wt. of polymers, relating to the total of all components of the aqueous polymer solution.

44. The process according to claim 26, wherein the aqueous polymer composition is an aqueous polymer concentrate comprising 3.1% to 14.9% by wt. of polymers, relating to the total of all components of the aqueous polymer concentrate.

45. The process according to claim 26, wherein the water-solubility of the water-soluble, monoethylenically unsaturated monomers is at least 50 g/l at room temperature.

46. The process according to claim 26, wherein the process comprises a further process step [4] of transporting the aqueous polymer composition from location A to a different location B.

47. The process according to claim 46, wherein the transport is carried out by means of a pipeline.

48. The process according to claim 46, wherein the aqueous polymer composition is filled into a suitable transport unit and the transport unit is transported from location A to location B.

49. The process according to claim 48, wherein process step [3] is carried out in course of step transporting the aqueous polymer composition in the transport unit.

50. The process according to claim 26, wherein the aqueous polymer gels are aqueous polyacrylamide gels.
